(19) United States
(12) Patent Application Publication
(10) Pub. No.: US 2026/0359202 A1
(43) Pub. Date: Nov. 12, 2026

(54) TESTING DISTRIBUTED APPLICATION WORKFLOWS BASED ON AUTOMATED USER INTERFACE INTERACTIONS

(71) Applicant: Morgan Stanley Services Group Inc., New York, NY (US)

(72) Inventor: Anindya Kumar Roy, Princeton, NJ (US)

(21) Appl. No.: 19/201,727

(22) Filed: May 7, 2025

(51) Int. Cl. G06F 11/3668; G06F 21/62

(52) U.S. Cl. CPC G06F 11/3688; G06F 21/62; G06F 2221/2141

(57) ABSTRACT

A system and related methods for testing a workflow associated with multiple user roles in a distributed computing environment is disclosed. The workflow comprises workflow steps associated with user interactions with computer applications in specific user roles. The system is programmed to manage testing programs that simulate user interactions in testing the workflow, including launching and terminating the testing programs on demand and assigning them to workflow steps. Each testing program has a profile that indicates the testing program's capabilities as well as a current host and a schedule of automatically interacting with computer applications for workflow steps. The system is programmed to assign testing programs to workflow steps by matching profiles of the testing programs with requirements of the workflow steps.

### TECHNICAL FIELD

The present disclosure relates to testing computer workflows, and more particularly to automating distributed simulation of user interactions with computer applications.

### BACKGROUND

A modern computer workflow can have many interconnected steps to be performed using computer application. Some of the steps can further require interactions with the computer applications by users in different user roles. Executing such a computer workflow often involves waiting for at least one user to interact with an appropriate computer application, undesirably extending the total execution time and delaying the production of expected work products.

It would be helpful to be able to test the computer workflow efficiently with minimum total execution time. This would be especially helpful when the computer workflow is subject to constant modification that could require further interactions with the computer applications by users in additional user roles.

### SUMMARY

The appended claims may serve as a summary of the invention.

### BRIEF DESCRIPTION OF THE DRAWINGS

Example embodiments will now be described by way of non-limiting examples with reference to the accompanying drawings, in which:

FIG. 1 illustrates an example networked computer system in which various embodiments may be practiced;

FIG. 2A illustrates an example workflow specification;

FIG. 2B illustrates an example extended workflow specification;

FIG. 2C illustrates an example shared workflow log.

FIG. 3 illustrates a process of testing a workflow associated with multiple user roles in a distributed computing environment in accordance with disclosed embodiments;

FIG. 4 illustrates an example computer system upon which various embodiments may be implemented.

### DETAILED DESCRIPTION OF CERTAIN EMBODIMENTS

In the following description, for the purposes of explanation, numerous specific details are set forth in order to provide a thorough understanding of the example embodiment(s) of the present invention. It will be apparent, however, that the example embodiment(s) may be practiced without these specific details. In other instances, well-known structures and devices are shown in block diagram form in order to avoid unnecessarily obscuring the example embodiment(s).

### 1. General Overview

A system and related methods for testing a workflow associated with multiple user roles in a distributed computing environment is disclosed. The workflow comprises workflow steps associated with user interactions with computer applications in specific user roles. The system is programmed to manage testing programs that simulate user interactions in testing the workflow, including launching and terminating the testing programs on demand and assigning them to workflow steps. Each testing program has a profile that indicates the testing program's capabilities as well as a current host and a schedule of automatically interacting with computer applications for workflow steps. The system is programmed to assign testing programs to workflow steps by matching profiles of the testing programs with requirements of the workflow steps.

In some embodiments, the system is programmed to test a workflow having a plurality of steps to be performed with computer applications in a distributed environment, where some of the steps involve user interactions with the computer applications in different user roles. For example, the workflow can include a step of a first user account submitting an electronic form using a first computer application, a second step of enhancing the electronic form using a second computer application, and a third step of a second user account approving the electronic form using a third computer application. The computer applications can run on different devices, and the user accounts can also access the computer applications from different devices.

In some embodiments, the system is programmed to analyze each step of the workflow according to a workflow specification and find a testing program or a bot that can simulate any user interactions involved in the step based on a bot profile. The system can be programmed to manage a dynamic pool of bots, launching them and terminating them on demand and matching them with the steps of different workflow for best overall performance in the distributed computing environment. The system is first programmed to find a bot that is available and capable of simulating the relevant user interactions. For example, when the computer application involved in a step runs on a specific platform, the bot needs to be able to automatically submit interactions with a user interface (UI) on that platform. To optimize the overall performance, the system is further programmed to evaluate the current state of a bot, the current state of the bot's host, and the overall state of the distributed computing environment.

For example, it can save time, reduce network congestion, or balance workloads to find a bot that is already instantiated and associated with the proper user role, that is located close to the computer application to be interacted with, or that runs on a host having a light workload.

In some embodiments, the system is programmed to test the workflow by executing each step of the workflow using a test script according to the control flow logic of the workflow. The execution of a step can include setting up a test user account associated with the bot found for the step in the proper user role and running the bot. Each computer program and bot involved in the workflow can generate a log on its host. The system is programmed to then collect such logs and reorganize the log entries to have a new log in chronological order. In response to a test failure, the system can be programmed to further analyze the new log to find the root cause of the problem.

The system disclosed herein has several technical benefits. By managing a pool of bots that can automatically submit interactions with UIs, the system can not only eliminate uncertainty and overhead associated with actual user accounts but further optimize the workflow execution and overall resource utilization. Specifically, the bots are created and destroyed on demand without utilizing excessive resources, and they are chosen to minimize startup time or reduce network communication. By making the testing process efficient, especially the testing process for multi-step, distributed execution governed by complex control flow rules that can be modified repeatedly and in various ways, the system reduces the time to production and quality of operation in the production environment.

### 2. Example Computing Environments

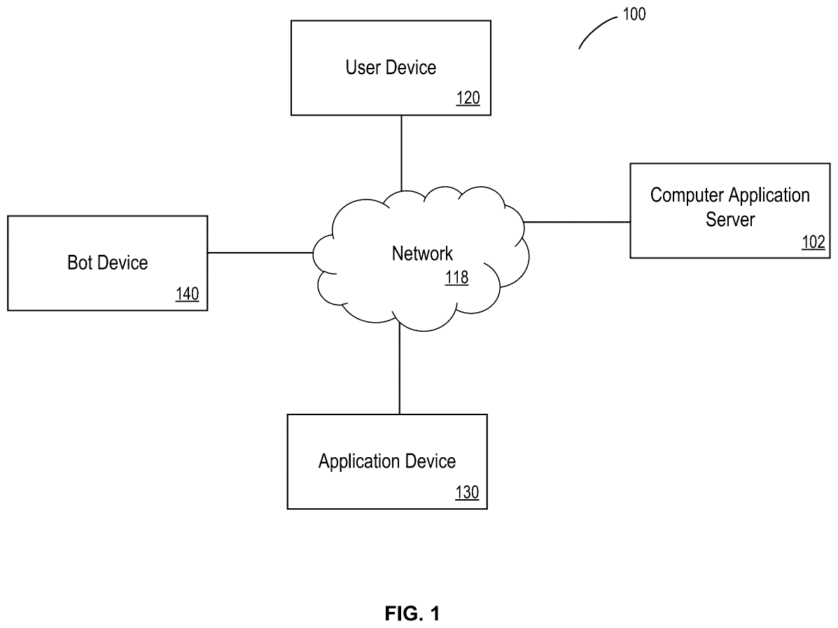

FIG. 1 illustrates an example networked computer system in which various embodiments may be practiced. FIG. 1 is shown in simplified, schematic format for purposes of illustrating a clear example and other embodiments may include more, fewer, or different elements.

In some embodiments, a networked computer system 100 comprises a computer application server (“server”) 102, a user device 120, an application device 130, and a bot device 140, which are communicatively coupled through direct physical connections or via a network 118.

In some embodiments, the user device 120 is programmed or configured to develop a workflow involving one or more computer applications, obtain an automated test case for the workflow, or request executing the workflow. The workflow includes multiple interconnected steps, and each step can be associated with one or more actions to be performed by users in one or more user roles. The same user device or different user devices can perform one or more of these tasks. The user device 120 node can comprise a personal computing device, such as a desktop computer, laptop computer, or tablet computer.

In some embodiments, the application device 130 is programmed or configured to host a computer application involved in a workflow, offering an execution environment for the computer application. Each application device can host any number of computer applications that can run in the execution environment. Each computer application can have a user interface (UI), such as a graphical UI (GUI), to handle user interactions. The application device 130 can include an integrated output device to support the GUI.

In some embodiments, the bot device 140 is programmed or configured to host a computer program that acts as a bot, offering an execution environment for the computer program. The bot performs actions associated with workflow steps under test conditions, including simulating user interactions with a computer application. Each bot device can similarly host any number of computer programs that can run in the execution environment. The bot device 140 can comprise any centralized or distributed computing facility with sufficient computing power in data processing, data storage, and network communication for performing the above-mentioned functions.

In some embodiments, the server 102 is programmed or configured to manage testing of a workflow involving one or more computer applications, including controlling utilization of one or more bots to programmatically perform actions that involve the GUIs of the one or more computer applications. The server 102 can comprise any centralized or distributed computing facility with sufficient computing power in data processing, data storage, and network communication for performing the above-mentioned functions. In certain embodiments, one or more of the user device 120, the application device 130, and the bot device 140 can be merged into another or incorporated into the server 102.

The network 118 may be implemented by any medium or mechanism that provides for the exchange of data between the various elements of FIG. 1. Examples of the network 118 include, without limitation, one or more of a cellular network, communicatively coupled with a data connection to the computing devices over a cellular antenna, a near-field communication (NFC) network, a Local Area Network (LAN), a Wide Area Network (WAN), or the Internet, a terrestrial or satellite link.

In some embodiments, the server 102 is programmed or configured to receive a workflow specification defining a workflow and a collection of test cases for testing the workflow from the user device 120. The server 102 is programmed to identify and select or schedule one or more bots for performing the actions associated with the workflow steps. In addition, the server 102 is programmed to execute the workflow. Specifically, the server 102 is programmed to collect input data for a workflow step, which can be specified in the workflow specification or a test case or produced by another workflow step. The server 102 is programmed to send a request to an appropriate application device 130 to initiate or continue executing a computer application involved in a workflow step based on the input data. The server 102 is also programmed to send a request to an appropriate bot device 140 to initiate or continue executing a bot for performing any action associated with the workflow step based on the input data or additional context data. The server 102 is further programmed to receive any output data of the workflow step from the application device 130 and the bot device 140, including log data.

### 3. Functional Descriptions

### 3.1. Analyzing Workflow Specifications

In some embodiments, the server 102 is programmed to have access to application profiles for computer applications installed in a distributed computing environment. An application profile can specify various application attributes, such as the storage location, access control, required platform (e.g., a Web browser or specific operating system for a desktop computer or a mobile device), or required user input. Each application attribute can have a default value. Some of the attributes can have dynamic values, such as the execution host. The server 102 is programmed to also have access to user role definitions for user accounts of the distributed computing environment. A user role definition can specify various user permissions for a user account to access the computer applications or computer devices in the distributed computing environment, such as a user permission to execute a feature of a user interface for a computer application or a user permission to store a file generated by a computer application on a computer node. Similarly, each user permission can have a default value.

In some embodiments, the server 102 is programmed to receive a workflow specification for a workflow to be tested in the distributed computing environment. A workflow in this context refers a set of interconnected steps involving one or more computer applications, where the steps are to be executed in a specific order using the one or more computer applications and data is passed between connected steps. The workflow can include any type of control flow logic to establish the interconnection, such as sequencing, branching, nesting, looping, switching, or conditioning. In addition, a step can be associated with one or more actions, including those that require user input. For example, a first step could involve a first user of a first user account filling out and submitting an electronic form using a first computer application, and a second step could involve a second user of a second user account reviewing the electronic form and providing an approval using a second computer application. A workflow specification then includes information for each step.

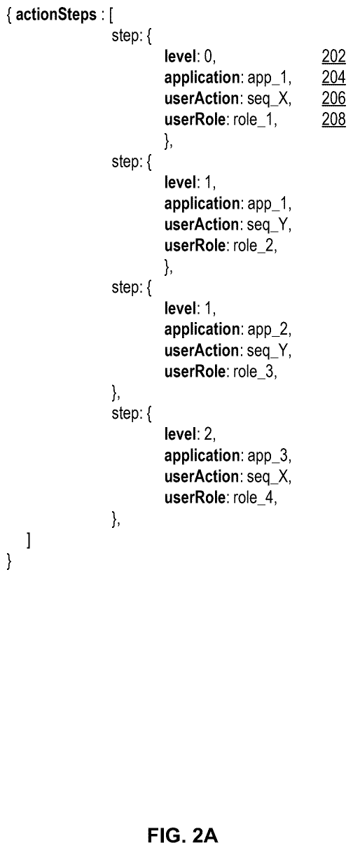

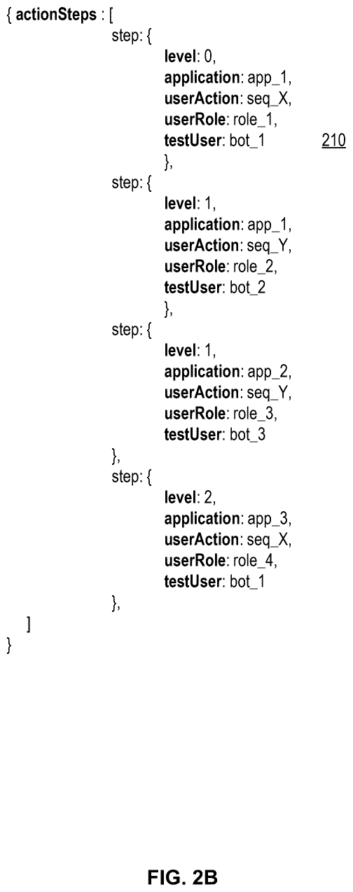

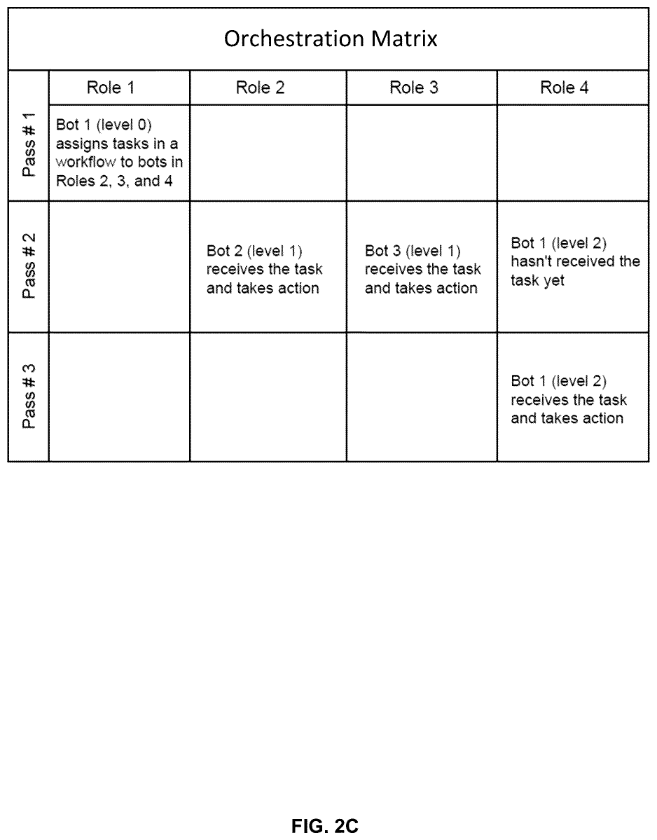

FIG. 2A illustrates an example workflow specification. For each step, the workflow specification indicates level information, such as the attribute 202. The level information corresponds to a stage in a sequence of stages in which the workflow progresses. Generally, the steps that belong to the same stage can be performed independently. Next, the workflow specification can indicate application information, such as the attribute 204. The application information identifies the computer application used in executing the step. The workflow specification can also indicate user action information, such as the attribute 206. The user action information identifies one or more user interactions with the computer application via a UI, including a graphical UI. Each user interaction can be defined by identifying a graphical element of the UI when available and an interaction type. Examples of user interactions include entering text into a first text field or clicking on a second button. In addition, the workflow specification can indicate user role information, such as the attribute 208. The user role information identifies a user role having a distinct set of access permissions.

In some embodiments, the server 102 can be programmed to look up an application profile based on the application information in the workflow specification. The server 102 can also be programmed to look up a user role definition based on the user role information in the workflow specification. Alternatively, one or more portions of an application profile or a user role definition can be incorporated into the workflow specification. In certain embodiments, the workflow specification can include additional information for each step, such as a nesting index that specifies the nesting level within an outer stage of the workflow, other indicators for different types of control flow logic, the purpose of the step or an identification of one or more computer actions performed directed by computer applications. The workflow specification can be implemented in various formats. For example, the different pieces of information can be stored as values of database columns or key-value pairs arranged in a flat list, a hierarchy, or another structure.

In some embodiments, the server 102 is also programmed to receive a set of test cases for one or more steps in the workflow specification. Each test case can specify a list of user or computer actions and the input data for each action. For example, an action can be entering text into a first text field and the input data can be the text to be entered into the first text field. The test case can also specify relevant configuration values. For example, the action can trigger another action of automatically sending an email message to an email address, which may have a configurable value. In addition, the test case can specify the expected output data for each action. For example, the expected output data can be the email message sent to that email address. The set of test cases can be incorporated into the workflow specification. In different embodiments, information regarding computer applications, user roles, or actions involved in a workflow can be described at different granularities in different documents or data sources that can be cross-referenced to enable retrieval of all data required for testing the workflow.

### 3.2. Determining Bots for Test Execution

In some embodiments, the server 102 is programmed to determine bots for testing the workflow. A bot in this context refers to a computer program that programmatically simulates one or more user interactions with one or more computer applications via a GUIs. The bot can be implemented as an object class that can be dynamically instantiated to execute relevant methods and uninstantiated, as code that can be dynamically loaded for execution and unloaded, or using another mechanism known to those skilled in the art that allows the bot to be launched and terminated on demand. The bot can also be implemented via a new thread or a new microservice to allow the bot to be launched and terminated on demand.

Function-wise, the bot can interact with a computer application via a GUI running on the same device (with an integrated display component) where the bot is running or a computer application via a GUI running on a difference device. In either case, the bot delivers programmatic interactions with the GUI using known methods for automating GUI actions. For example, the bot can rely on an application programming interface (API) supported by a browser running on another device to send interactions to the browser as a GUI for a computer application running within the browser.

In some embodiments, the server 102 is programmed to create, update, or retrieve a bot profile for a bot. The bot profile can specify various bot attributes, such as those shared by a computer application noted above and additional ones, which can include the bot user account to enable a bot to represent a user, the target platform of a computer application with which the bot is capable of interacting or a schedule of any past, current, or future performances, as further discussed below. Each bot attribute can have a default value. Some of these bot attributes can have dynamic values, such as the current execution host or the current schedule of performances.

In some embodiments, the server 102 is programmed to determine a bot for each step of a workflow. The determination can be performed using one or more of a variety of methods depending on when each bot is determined, how each bot is launched and terminated, or other factors. In terms of when the determination is made, all the bots can be determined before any step is executed, which can minimize the total time of executing the workflow. Alternatively, a bot can be determined for a step to be executed after one or more steps are already executed, which allows current resource utilization to be taken into consideration in scheduling the bot. In terms of how each bot is launched and terminated, in one scenario, the server 102 can be programmed to adopt greedy resource-reuse scheduling to reuse active bots when possible, launch new bots when necessary, and terminate all the bots when all the steps have been executed. In another scenario, the server 102 can be programmed to adopt elastic scheduling to not only reuse active bots when possible but also continuously launch and terminate bots to meet timing or other resource utilization constraints. For example, the server 102 can be configured to keep a bot active upon determining that the bot can be selected for at least one remaining step of this workflow or another workflow, as further discussed below. Generally, reusing a bot not only avoids allocating additional resources computing to running a bot but also reduces the time required to re-instantiate or reset up the bot, as further discussed below. On the other hand, keeping a bot alive for reuse means that the bot continues to utilize computing resources even if it may need to be idle sometimes.

In some embodiments, to decide whether an active bot can be selected for a specific step of a workflow, the server 102 is programmed to evaluate the description of the specific step in the workflow specification against each bot profile. A basic goal is to find a bot that can interact with the computer application for this specific step. For example, a match is to be found between the computer application's platform attribute and the bot's target platform attribute. A match is also to be found between the time of executing the specific step and the bot's availability. A duration of each step of the workflow can be pre-estimated and specified in the workflow specification or can be dynamically estimated using machine learning techniques based on recent test runs. Specifically, the server 102 can be programmed to predict the execution time of a workflow from some or all the bot attributes and workflow attributes for recent test runs of all by learning the relationship between the execution time and the set of bot or workflow attributes over recent test runs. The duration can then be used to determine the time of executing the specific step and the bot's availability given all the scheduled performances of workflow steps. Additional goals can include balancing network workloads, reducing network congestion, or minimizing local resource utilization. Therefore, the server 102 can be programmed to prefer a bot that is running on a host that has relatively low resource utilization, that is closer to the computer application with which the bot is to interact, that can be woken up from a sleep state relatively quickly, or that is already associated with a certain user role compatible with the user role for this specific step.

In some embodiments, the server 102 can be programmed to enhance the workflow specification with the bot determination result to obtain an extended workflow specification for future reference. FIG. 2B illustrates an example extended workflow specification. For each step, the extended workflow specification now also indicates the bot determined for the step, such as the attribute 210. As can be seen, each bot could be scheduled for multiple steps, such as bot_1 to simulate the user action for the step at level_0 and also simulate the user action for the step at level_2. Each bot will be set up for the appropriate user role for each scheduled step, as further discussed below.

### 3.3. Testing Workflows Using Determined Bots

In some embodiments, the server 102 is programmed to test the workflow based on the workflow specification, supporting data, and an identification of one or more bots for one or more steps of the workflow. The server 102 can be programmed to manage executing the workflow, including running appropriate applications on appropriate hosts according to applicable control flow, setting appropriate configurations, passing data between steps, or handling workflow errors, using known workflow management methods. The workflow specification includes information for each step for unit testing purposes. Therefore, the server 102 is programmed to separately handle testing each step of the workflow, as further discussed below, including providing input data to an appropriate computer application, enabling the determined bot to interact with the computer application, making appropriate assertions, or collecting output data or separate log data from the computer application or the bot.

In some embodiments, before executing a step of the workflow, the server 102 is programmed to instantiate a bot (when not reusing a bot) on an appropriate host, set up the bot in the user role for the step (when not reusing the user role) by granting corresponding permissions to access computer applications or devices to the associated bot user account, and run the bot. The server 102 is further programmed to create or update the bot profile, as discussed above, which can facilitate further scheduling of the bots. Each bot can record relevant information into a log in executing the step similar to the computer application involved the step. The information can identify the bot, the associated bot profile, or the step. The information can further include details of each step to identify each action being performed, the time of performance, the input data, the output data, any error condition, or any assertion result. After executing the step, the server 102 can be programmed to strip the bot user account of the user role to prevent malicious use of the bot. The server 102 is also programmed to terminate the bot according to the scheduling method or an execution plan, as discussed above.

In some embodiments, the server 102 is programmed to distribute part of management of executing the workflow among the bots. Each bot once launched can additionally determine, for each scheduled performance of a workflow step, where to collect input data for the workflow step and when to perform the workflow step based on the workflow specification and each bot's bot profile. For example, referring back to FIG. 2B, bot_1 scheduled to perform the step at level 2 could set itself up for role_4 and update its bot profile.

Upon receiving notifications bot_2 and bot_3 have executed the respective workflow steps at level 1, bot_1 can collect input data where bot_2 runs and bot_3 runs and execute the workflow step at level 2. For notification purposes, each bot, such as bot_1 can record relevant information in a log designated in the bot profile, as further discussed below. FIG. 2C illustrates an example shared workflow log. This log has a matrix form, where each row represents a level (or pass) of a workflow and each column represents a user role for a step of the workflow. Each bot could write in the entry corresponding to a scheduled step for the corresponding level and user role. Each bot could also read the entries for the previous level to determine whether execution is complete. More broadly, each bot could comply with different types of control flow logic. When nesting is present, for example, a row of the matrix could also represent a nesting index, and the bot would instead read the entries for the inner nesting index to determine whether execution is complete.

In terms of log creation, all computer applications including bots can write to the same log through database transactions. On the other hand, individual computer applications can write to their logs on the local hosts and request transfer of or remote access to these local logs after execution of the workflow is complete. Whatever the situation might be, the server 102 can be programmed to reorganize the log entries into a new log where the log entries are in chronological order. In response to a test failure, the server 102 can be programmed to analyze the new log and diagnose potential problems using various known techniques.

In some embodiments, upon successfully executing the workflow in one or more test runs, the server 102 is programmed to transmit a notification of the success. The server 102 can be programmed to then deploy the workflow in a production environment.

### 4. Example Processes

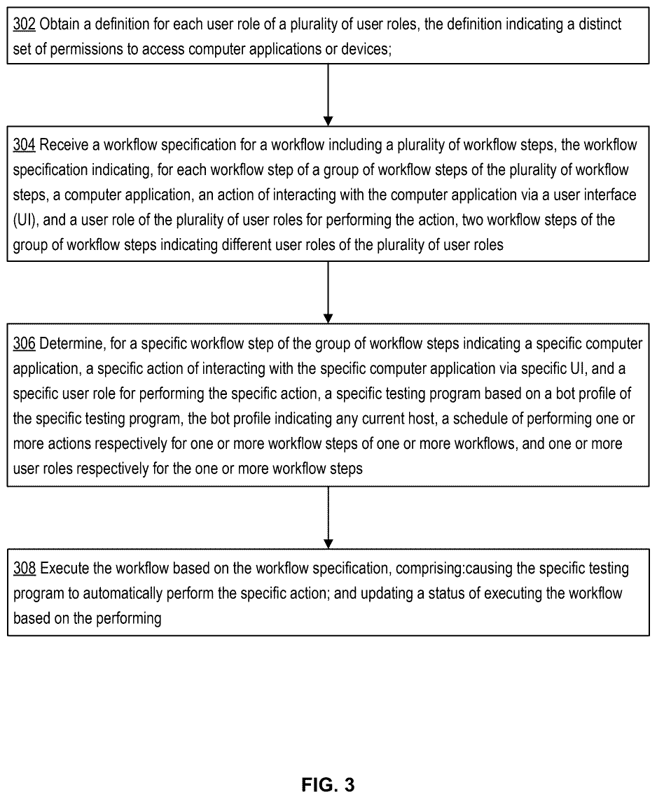

FIG. 3 illustrates a process of testing a workflow associated with multiple user roles in a distributed computing environment in accordance with disclosed embodiments. FIG. 3 is shown in simplified, schematic format for purposes of illustrating a clear example and other embodiments may include more, fewer, or different elements connected in various manners.

FIG. 3 is intended to disclose an algorithm, plan, or outline that can be used to implement one or more computer programs or other software elements which when executed cause performing the functional improvements and technical advances that are described herein. Furthermore, the flow diagrams herein are described at the same level of detail that persons of ordinary skill in the art ordinarily use to communicate with one another about algorithms, plans, or specifications forming a basis of software programs that they plan to code or implement using their accumulated skill and knowledge.

In step 302, the server 102 is programmed or configured to obtain a definition for each user role of a plurality of user roles. The definition indicates a distinct set of permissions to access computer applications or devices.

In step 304, the server 102 is programmed or configured to receive a workflow specification for a workflow including a plurality of workflow steps. The workflow specification indicates, for each workflow step of a group of workflow steps of the plurality of workflow steps, a computer application, an action of interacting with the computer application via a UI, and a user role of the plurality of user roles for performing the action, and two workflow steps of the group of workflow steps indicate different user roles of the plurality of user roles.

In step 306, the server 102 is programmed or configured to determine, for a specific workflow step of the group of workflow steps indicating a specific computer application, a specific action of interacting with the specific computer application via specific UI, and a specific user role for performing the specific action, a specific testing program based on a bot profile of the specific testing program. The bot profile indicates any current host, a schedule of performing one or more actions respectively for one or more workflow steps of one or more workflows, and one or more user roles respectively for the one or more workflow steps.

In some embodiments, the specific action includes one or more interactions with the specific computer application, the UI is a graphical UI, and each interaction of the one or more interactions is defined by an identification of a graphical element of the graphical UI and a graphical interaction type.

In some embodiments, the bot profile for the specific testing program further indicates a target platform of a computer application with which the specific testing program interacts. The determining then comprises confirming that the specific testing program is available when the specific workflow step is performed based on the schedule and is capable of interacting with the specific computer application to perform the specific action based on the target platform. In certain embodiments, the determining comprises confirming that the specific testing program is already in the specific user role from performing an immediately previous workflow step on the schedule. In other embodiments, the specific computer application runs on an application device. The determining then comprises identifying a testing program for which the current host is closest to the application device, a testing program that is closest to a data device storing input data for the specific workflow step, or a testing program that has a resource utilization below a certain threshold.

In some embodiments, the determining is performed for the plurality of workflow steps before the executing. In certain embodiments, the determining comprises confirming that no testing program is available when the specific workflow step is performed and launching a new testing program.

In step 308, the server 102 is programmed or configured to execute the workflow based on the workflow specification. That comprises causing the specific testing program to automatically perform the specific action; and updating a status of executing the workflow based on the performing.

In some embodiments, the workflow specification includes control flow logic that interconnects the plurality of workflow steps. The control flow logic includes sequencing, branching, nesting, looping, switching, or conditioning. Executing the workflow then comprises executing the plurality of workflow steps according to the control flow logic.

In some embodiments, the server 102 is programmed or configured to terminate the specific testing program before the executing is complete, including releasing resources allocated to the specific testing program.

In some embodiments, the causing comprises granting the distinct set of permissions for the specific user role to a user account associated with the specific testing program.

In some embodiments, the server 102 is programmed or configured to collect a plurality of logs from a plurality of devices in the distributed computing environment generated by a plurality of computer applications or testing programs, each log of the plurality of logs including one or more entries having respective timestamps. The server 102 is further programmed or configured to create an updated log by reordering the entries in the plurality of logs based on the timestamps.

In some embodiments, the workflow specification includes or linking to a test script or a collection of test cases for the workflow. The updating comprises detecting an error based on a failed assertion specified in the test script or the collection of test cases. The server 102 is further programmed or configured to analyze the updated log and transmit a diagnosis of the error.

### 5. Example Implementation

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

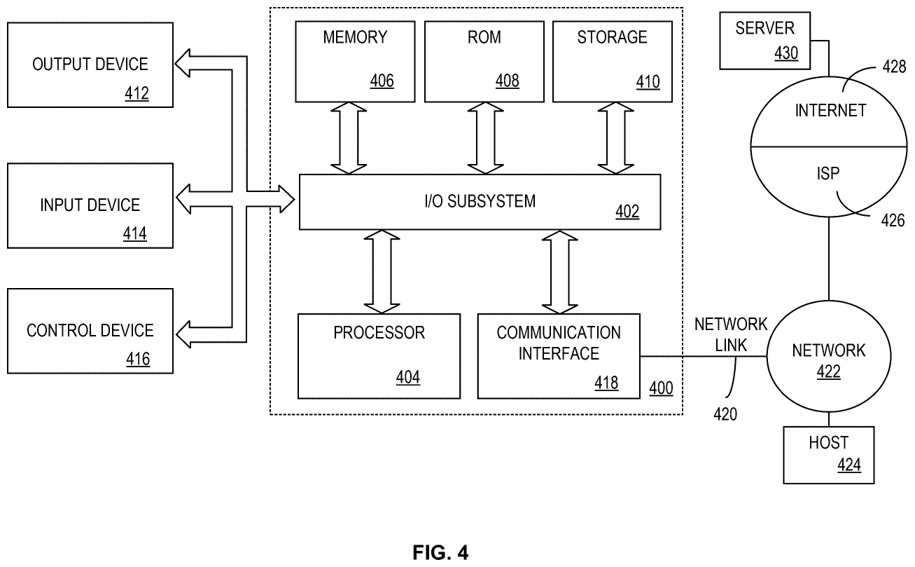

FIG. 4 illustrates an example computer system upon which various embodiments may be implemented. In the example of FIG. 4, a computer system 400 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 400 includes an input/output (I/O) subsystem 402 which may include a bus and/or other communication mechanism(s) for communicating information and/or instructions between the components of the computer system 400 over electronic signal paths.

The I/O subsystem 402 may include an I/O controller, a memory controller and at least one I/O port. The electronic signal paths are represented schematically in the drawings, for example as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU) or a digital signal processor or Advanced RISC Machines (ARM) processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read only memory (ROM) 408 or other static storage device coupled to I/O subsystem 402 for storing information and instructions for processor 404. The ROM 408 may include various forms of programmable ROM (PROM) such as erasable PROM (EPROM) or electrically erasable PROM (EEPROM). A unit of persistent storage 410 may include various forms of non-volatile RAM (NVRAM), such as flash memory, or solid-state storage, magnetic disk, or optical disk such as CD-ROM or DVD-ROM, and may be coupled to I/O subsystem 402 for storing information and instructions. Storage 410 is an example of a non-transitory computer-readable medium that may be used to store instructions and data which when executed by the processor 404 cause performing computer-implemented methods to execute the techniques herein.

The instructions in memory 406, ROM 408 or storage 410 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement Transmission Control Protocol/Internet Protocol (TCP/IP), Hypertext Transfer Protocol (HTTP) or other communication protocols; file processing instructions to interpret and render files coded using HTML, XML, Joint Photographic Experts Group (JPEG), Moving Picture Experts Group (MPEG) or Portable Network Graphics (PNG); user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or NoSQL, an object store, a graph database, a flat file system or other data storage.

Computer system 400 may be coupled via I/O subsystem 402 to at least one output device 412. In one embodiment, output device 412 is a digital computer display. Examples of a display that may be used in various embodiments include a touch screen display or a light-emitting diode (LED) display or a liquid crystal display (LCD) or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators, or servos.

At least one input device 414 is coupled to I/O subsystem 402 for communicating signals, data, command selections or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical user interface on a display screen, alternatively or in addition to input functions. Control device 416 may be a touchpad, a mouse, a trackball, or cursor direction keys for communicating direction information and command selections to processor 404 and for controlling cursor movement on the output device 412. The input device may have at least two degrees of freedom in two axes, a first axis (e.g., x) and a second axis (e.g., y), that allows the device to specify positions in a plane.

Another type of input device is a wired, wireless, or optical control device such as a joystick, wand, console, steering wheel, pedal, gearshift mechanism or other type of control device. An input device 414 may include a combination of multiple different input devices, such as a video camera and a depth sensor.

In another embodiment, computer system 400 may comprise an internet of things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400.

Output device 412 may include hardware, software, firmware, and interfaces for generating position reporting packets, notifications, pulse or heartbeat signals, or other recurring data transmissions that specify a position of the computer system 400, alone or in combination with other application-specific data, directed toward host computer 424 or server 430.

Computer system 400 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 402. Transmission media can also take the form of acoustic or light waves, such as those generated during radio-wave and infra-red data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to be read by computer system 400. For instance, a receiver such as a radio frequency antenna or an infrared detector can receive the data carried in a wireless or optical signal and appropriate circuitry can provide the data to I/O subsystem 402 such as place the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to I/O subsystem 402. Communication interface 418 provides a two-way data communication coupling to network link(s) 420 that are directly or indirectly connected to at least one communication network, such as a network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 422 broadly represents a LAN, WAN, campus network, internetwork, or any combination thereof.

Communication interface 418 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic, or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through a network 422 to a host computer 424.

Furthermore, network link 420 may provide a connection through network 422 or to other computing devices via internetworking devices and/or computers that are operated by an Internet Service Provider (ISP) 426. ISP 426 provides data communication services through a world-wide packet data communication network represented as internet 428. A server 430 may be coupled to internet 428. Server 430 broadly represents any computer, data center, virtual machine, or virtual computing instance with or without a hypervisor, or computer executing a containerized program system such as DOCKER or KUBERNETES. Server 430 may represent an electronic digital service that is implemented using more than one computer or instance and that is accessed and used by transmitting web services requests, Uniform Resource Locator (URL) strings with parameters in HTTP payloads, application programming interface (API) calls, app services calls, or other service calls. Computer system 400 and server 430 may form elements of a distributed computing system that includes other computers, a processing cluster, server farm or other organization of computers that cooperate to perform tasks or execute applications or services. Server 430 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 430 may comprise a web application server that hosts a presentation layer, application layer and data storage layer such as a relational database system using SQL or NoSQL, an object store, a graph database, a flat file system or other data storage.

Computer system 400 can send messages and receive data and instructions, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage 410, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 6. Extensions and Alternatives

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

1. A method of testing a workflow associated with multiple user roles in a distributed computing environment, comprising:
obtaining a definition for each user role of a plurality of user roles, the definition indicating a distinct set of permissions to access computer applications or devices;
receiving a workflow specification for a workflow including a plurality of workflow steps,
the workflow specification indicating, for each workflow step of a group of workflow steps of the plurality of workflow steps, a computer application, an action of interacting with the computer application via a user interface (UI), and a user role of the plurality of user roles for performing the action,
two workflow steps of the group of workflow steps indicating different user roles of the plurality of user roles;
determining a specific testing program based on a dynamic bot profile of the specific testing program, for a specific workflow step of the group of workflow steps indicating a specific computer application, a specific action of interacting with the specific computer application via specific UI, and a specific user role for performing the specific action,
the bot profile changing as the workflow is executed,
the bot profile of the specific testing program indicating any current host on which the specific testing program runs, a schedule of performing one or more actions by the specific testing program respectively for one or more workflow steps of one or more workflows, and one or more user roles assumed by the specific testing program respectively for the one or more workflow steps;
executing the workflow based on the workflow specification, comprising:
causing the specific testing program to automatically perform the specific action for the specific workflow step; and
updating a status of executing the workflow based on the performing; and
terminating the specific testing program before the executing is complete, including releasing resources allocated to the specific testing program,
wherein the method is performed by one or more processors.

2. The method of claim 1,
the specific action including one or more interactions with the specific computer application,
the UI being a graphical UI,
each interaction of the one or more interactions being defined by an identification of a graphical element of the graphical UI and a graphical interaction type.

3. The method of claim 1,
the workflow specification including control flow logic that interconnects the plurality of workflow steps,
the control flow logic including sequencing, branching, nesting, looping, switching, or conditioning,
executing the workflow comprising executing the plurality of workflow steps according to the control flow logic.

4. The method of claim 1,
the bot profile for the specific testing program further indicating a target platform of a computer application with which the specific testing program interacts,
the determining comprising confirming that the specific testing program is available when the specific workflow step is performed based on the schedule and is capable of interacting with the specific computer application to perform the specific action based on the target platform.

5. The method of claim 1, the determining comprising confirming that the specific testing program is already in the specific user role from performing an immediately previous workflow step on the schedule.

6. The method of claim 1,
the specific computer application running on an application device,
the determining comprising identifying a testing program for which the current host is closest to the application device, a testing program that is closest to a data device storing input data for the specific workflow step, or a testing program that has a resource utilization below a certain threshold.

7. The method of claim 1, the determining being performed for the plurality of workflow steps before the executing.

8. The method of claim 1, the determining comprising:
confirming that no testing program is available when the specific workflow step is performed;
launching a new testing program.

9. The method of claim 1, the one or more workflow steps of the one or more workflows including two workflow steps of a common workflow.

10. The method of claim 1, the causing comprising granting the distinct set of permissions for the specific user role to a user account associated with the specific testing program.

11. The method of claim 1, further comprising:
collecting a plurality of logs from a plurality of devices in the distributed computing environment generated by a plurality of computer applications or testing programs,
each log of the plurality of logs including one or more entries having respective timestamps;
creating an updated log by reordering the entries in the plurality of logs based on the timestamps.

12. The method of claim 11,
the workflow specification including or linking to a test script or a collection of test cases for the workflow,
the updating comprising detecting an error based on a failed assertion specified in the test script or the collection of test cases,
the method further comprising analyzing the updated log and transmitting a diagnosis of the error.

13. A system for testing a workflow associated with multiple user roles in a distributed computing environment, comprising:
a memory;
one or more processors coupled with the memory and configured to perform:
obtaining a definition for each user role of a plurality of user roles, the definition indicating a distinct set of permissions to access computer applications or devices;
receiving a workflow specification for a workflow including a plurality of workflow steps,
the workflow specification indicating, for each workflow step of a group of workflow steps of the plurality of workflow steps, a computer application, an action of interacting with the computer application via a UI, and a user role of the plurality of user roles for performing the action,
two workflow steps of the group of workflow steps indicating different user roles of the plurality of user roles;
determining a specific testing program based on a dynamic bot profile of the specific testing program, for a specific workflow step of the group of workflow steps indicating a specific computer application, a specific action of interacting with the specific computer application via specific UI, and a specific user role for performing the specific action,
the bot profile changing as the workflow is executed,
the bot profile of the specific testing program indicating any current host on which the specific testing program runs, a schedule of performing one or more actions by the specific testing program respectively for one or more workflow steps of one or more workflows, and one or more user roles assumed by the specific testing program respectively for the one or more workflow steps;
executing the workflow based on the workflow specification, comprising:
causing the specific testing program to automatically perform the specific action for the specific workflow step; and
updating a status of executing the workflow based on the performing;
terminating the specific testing program before the executing is complete, including releasing resources allocated to the specific testing program.

14. The system of claim 13,
the specific action including one or more interactions with the specific computer application,
the UI being a graphical UI,
each interaction of the one or more interactions being defined by an identification of a graphical element of the graphical UI and a graphical interaction type.

15. The system of claim 13,
the bot profile for the specific testing program further indicating a target platform of a computer application with which the specific testing program interacts,
the determining comprising confirming that the specific testing program is available when the specific workflow step is performed based on the schedule and is capable of interacting with the specific computer application to perform the specific action based on the target platform.

16. The system of claim 13, the determining comprising confirming that the specific testing program is already in the specific user role from performing an immediately previous workflow step on the schedule.

17. The system of claim 13,
the specific computer application running on an application device,
the determining comprising identifying a testing program for which the current host is closest to the application device, a testing program that is closest to a data device storing input data for the specific workflow step, or a testing program that has a resource utilization below a certain threshold.

18. The system of claim 13, the determining comprising:
confirming that no testing program is available when the specific workflow step is performed;
launching a new testing program.

19. The system of claim 13, the causing comprising granting the distinct set of permissions for the specific user role to a user account associated with the specific testing program.

20. A non-transitory, computer-readable storage medium storing one or more sequences of instructions which when executed cause one or more processor to perform:
obtaining a definition for each user role of a plurality of user roles, the definition indicating a distinct set of permissions to access computer applications or devices;
receiving a workflow specification for a workflow including a plurality of workflow steps,
the workflow specification indicating, for each workflow step of a group of workflow steps of the plurality of workflow steps, a computer application, an action of interacting with the computer application via a UI, and a user role of the plurality of user roles for performing the action,
two workflow steps of the group of workflow steps indicating different user roles of the plurality of user roles;
determining a specific testing program based on a dynamic bot profile of the specific testing program, for a specific workflow step of the group of workflow steps indicating a specific computer application, a specific action of interacting with the specific computer application via specific UI, and a specific user role for performing the specific action,
the bot profile changing as the workflow is executed,
the bot profile of the specific testing program indicating any current host on which the specific testing program runs, a schedule of performing one or more actions by the specific testing program respectively for one or more workflow steps of one or more workflows, and one or more user roles assumed by the specific testing program respectively for the one or more workflow steps;
executing the workflow based on the workflow specification, comprising:
causing the specific testing program to automatically perform the specific action for the specific workflow step; and
updating a status of executing the workflow based on the performing;
terminating the specific testing program before the executing is complete, including releasing resources allocated to the specific testing program.
